(19) United States
(12) Patent Application Publication
(10) Pub. No.: US 2025/0193454 A1
(43) Pub. Date: Jun. 12, 2025

(54) MESH DECODING DEVICE, MESH DECODING METHOD, AND PROGRAM

(71) Applicant: KDDI CORPORATION, Tokyo (JP)

(72) Inventors: Hitoshi NISHIMURA, Fujimino-shi (JP); Kei KAWAMURA, Fujimino-shi (JP)

(73) Assignee: KDDI CORPORATION, Tokyo (JP)

(21) Appl. No.: 19/061,106

(22) Filed: Feb. 24, 2025

Related U.S. Application Data
(63) Continuation of application No. PCT/JP2023/045391, filed on Dec. 18, 2023.

(30) Foreign Application Priority Data
Dec. 28, 2022 (JP) 2022-212452

(51) Int. Cl. H04N 19/70; H04N 19/176; H04N 19/184

(52) U.S. Cl. CPC H04N 19/70; H04N 19/176; H04N 19/184

(57) ABSTRACT

A displacement decoding unit 206 of a mesh decoding device 200 according to the present invention includes a circuit, wherein the circuit: generates a binarization syntax by performing arithmetic decoding on a displacement bit stream, generates a binarization syntax by performing bypass arithmetic decoding that performs arithmetic decoding while fixing a context value on the displacement bit stream, generates a syntax by multi-value conversion of the binarization syntax, and generates a coefficient level value from the syntax.

### CROSS-REFERENCE TO RELATED APPLICATIONS

The present application is a continuation of PCT Application No. PCT/JP2023/045391, filed on Dec. 18, 2023, which claims the benefit of Japanese patent application No. 2022-212452 filed on Dec. 28, 2022, the entire contents of each application being incorporated herein by reference in its entirety.

### TECHNICAL FIELD

The present invention relates to a mesh decoding device, a mesh decoding method, and a program.

### BACKGROUND ART

Non Patent Literature 1: “Khaled Mammou, Jungsun Kim, Alexis Tourapis, Dimitri Podborski, Krasimir Kolarov; [V-CG] Apple's Dynamic Mesh Coding CfP Response; ISO/IEC JTC 1/SC 29/WG 7 m59281; April 2022” discloses a technique in which a mesh is divided into a rough base mesh and a detailed displacement and decoded, and the displacement is decoded by a video codec.

### SUMMARY OF THE INVENTION

However, the technique disclosed in Non Patent Literature 1 has a problem that the amount of calculation of the video codec used for decoding the displacement is large. Therefore, the present invention has been made in view of the above-described problems, and an object thereof is to provide a mesh decoding device, a mesh decoding method, and a program capable of reducing the amount of calculation.

A first feature of the present invention is a mesh decoding device including: a circuit that decodes a displacement bit stream to generate and output a displacement. The circuit: generates a binarization syntax by performing arithmetic decoding on the displacement bit stream; generates a binarization syntax by performing bypass arithmetic decoding in which arithmetic decoding is performed while a context value is fixed with respect to the displacement bit stream; generates the syntax by multi-value conversion of the binarization syntax; generates a coefficient level value from the syntax; generates a transformed coefficient by inversely quantizing the coefficient level value; and generates a displacement by applying an inverse wavelet transform to the transformed coefficient.

A second feature of the present invention is a mesh decoding method including: decoding a displacement bit stream to generate and output a displacement. The decoding includes: generating a binarization syntax by performing arithmetic decoding on the displacement bit stream; generating a binarization syntax by performing bypass arithmetic decoding in which arithmetic decoding is performed while a context value is fixed with respect to the displacement bit stream; generating the syntax by multi-value conversion of the binarization syntax; generating a coefficient level value from the syntax; generating a transformed coefficient by inversely quantizing the coefficient level value; and generating a displacement by applying an inverse wavelet transform to the transformed coefficient.

A third feature of the present invention is a program for causing a computer to function as a mesh decoding device. The mesh decoding device includes a circuit that decodes a displacement bit stream to generate and output a displacement. The circuit: generates a binarization syntax by performing arithmetic decoding on the displacement bit stream; generates a binarization syntax by performing bypass arithmetic decoding in which arithmetic decoding is performed while a context value is fixed with respect to the displacement bit stream; generates the syntax by multi-value conversion of the binarization syntax; generates a coefficient level value from the syntax; generates a transformed coefficient by inversely quantizing the coefficient level value; and generates a displacement by applying an inverse wavelet transform to the transformed coefficient.

According to the present invention, it is possible to provide a mesh decoding device, a mesh decoding method, and a program capable of reducing the amount of calculation.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3 is a diagram illustrating an example of functional blocks of a displacement decoding unit 206 of the mesh decoding device 200 according to an embodiment.

FIG. 4 is a diagram illustrating an example of a syntax configuration.

FIG. 5 is a diagram illustrating an example of syntax in which a decoding omission determination unit 206A1 can determine to omit decoding and an example of coefficients to be subjected to bypass arithmetic decoding by a bypass decoding determination unit 206A2.

FIG. 6 is a flowchart illustrating an example of an operation of the displacement decoding unit 206.

FIG. 7 is a flowchart illustrating an example of an operation of determination by syntax in units of coefficients.

### DESCRIPTION OF EMBODIMENTS

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

### First Embodiment

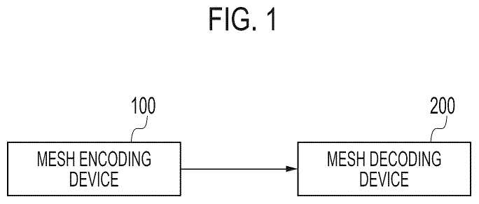

Hereinafter, a mesh processing system according to the present embodiment will be described with reference to FIGS. 1 to 7.

FIG. 1 is a diagram illustrating an example of a configuration of a mesh processing system 1 according to the present embodiment. As illustrated in FIG. 1, the mesh processing system 1 includes a mesh encoding device 100 and a mesh decoding device 200.

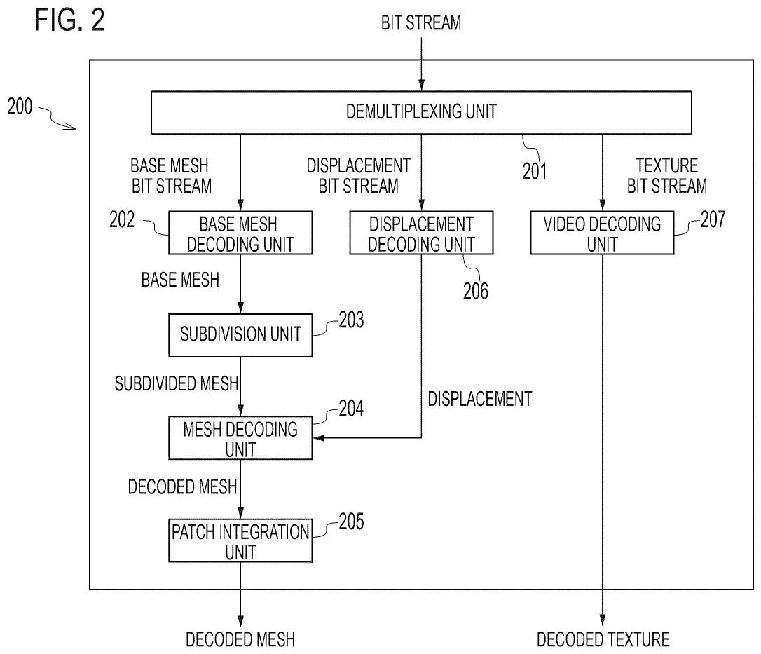

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a patch integration unit 205, a displacement decoding unit 206, and a video decoding unit 207.

A demultiplexing unit 201 is configured to separate the multiplexed bit stream into a base mesh bit stream, a displacement bit stream, and a texture bit stream.

A base mesh decoding unit 202 is configured to decode a base mesh bit stream, and generate and output a base mesh.

A subdivision unit 203 is configured to generate and output the added subdivided vertices and their connectivity information from the base mesh decoded by the base mesh decoding unit 202 by a subdivision method indicated by the control information.

Here, the base mesh, the added subdivided vertex, and the connectivity information thereof are collectively referred to as a “subdivided mesh”.

A mesh decoding unit 204 is configured to generate and output a decoded mesh using the subdivided mesh generated by the subdivision unit 203 and the displacement decoded by a displacement decoding unit 206.

A patch integration unit 205 is configured to integrate and output a plurality of patches of the decoded mesh generated by the mesh decoding unit 204.

The displacement decoding unit 206 is configured to decode a displacement bit stream to generate and output a displacement.

A video decoding unit 207 is configured to decode and output texture by video coding. For example, the video decoding unit 207 may use HEVC described in Non Patent Literature 1.

### (Displacement Decoding Unit 206)

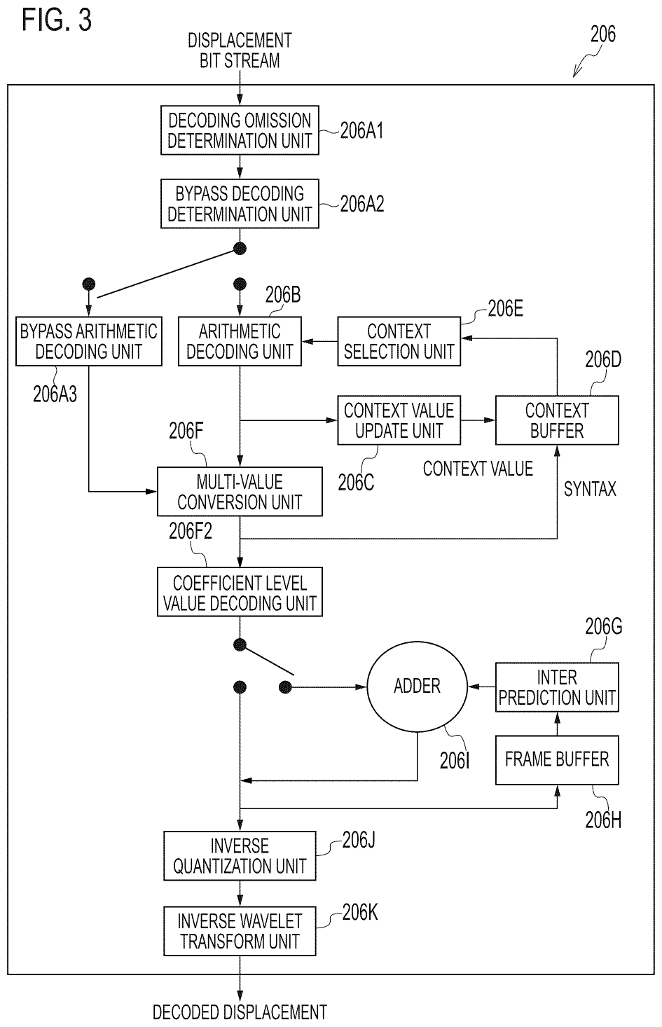

As illustrated in FIG. 3, the displacement decoding unit 206 includes a decoding omission determination unit 206A1, a bypass decoding determination unit 206A2, a bypass arithmetic decoding unit 206A3, an arithmetic decoding unit 206B, a context value update unit 206C, a context buffer 206D, a context selection unit 206E, a multi-value conversion unit 206F, a coefficient level value decoding unit F2, an inter prediction unit 206G, a frame buffer 206H, an adder 2061, an inverse quantization unit 206J, and an inverse wavelet transform unit 206K.

The decoding omission determination unit 206A1 is configured to determine whether decoding of some syntax is partially omitted and regarded as a predetermined value.

The bypass decoding determination unit 206A2 is configured to determine to which one of the arithmetic decoding unit 206B and the bypass arithmetic decoding unit 206A3 the received displacement bit stream is to be sent.

The arithmetic decoding unit 206B is configured to generate a binarization syntax by performing arithmetic decoding on the received displacement bit stream. Specifically, the arithmetic decoding unit 206B is configured to output a binarization syntax by performing arithmetic decoding while updating the context value with respect to the received displacement bit stream.

The context value update unit 206C is configured to update a context value using the binarization syntax and output the updated context value to the context buffer 206D.

The context selection unit 206E is configured to generate and output a context value (context value for output) using the context value, and the syntax read from the context buffer 206D.

The context buffer 206D is configured to obtain and accumulate context values, and syntax. The context buffer 206D is configured to output the context value and the syntax to the context selection unit 206E according to control information (not illustrated).

The bypass arithmetic decoding unit 206A3 is configured to generate a binarization syntax by performing arithmetic decoding while fixing a context value to the received displacement bit stream.

The multi-value conversion unit 206F is configured to generate and output syntax by multi-value conversion of the binarization syntax received from the arithmetic decoding unit 206B or the bypass arithmetic decoding unit 206A3. The generated (calculated) syntax is output to the coefficient level value decoding unit 206F2 and the context buffer 206D.

A coefficient level value decoding unit 206F2 is configured to generate and output a coefficient level value from syntax received from the multi-value conversion unit 206F.

The inter prediction unit 206G is configured to generate and output a predicted displacement using the reference frame read from the frame buffer 206H.

The frame buffer 206H is configured to acquire and accumulate coefficient level values from the adder 2061. The frame buffer 206H is configured to output the coefficient level value at the corresponding vertex in the reference frame according to control information (not illustrated).

The adder 2061 is configured to acquire the coefficient level value (prediction residual) from the coefficient level value decoding unit 206F2, and acquire the coefficient level value from the frame buffer 206H. The adder 2061 is configured to add the prediction residual and the coefficient level value to generate and output the coefficient level value (decoded displacement). The generated (calculated) coefficient level value (decoded displacement) is output to the inverse quantization unit 206J and the frame buffer 206H.

The inverse quantization unit 206J is configured to generate and output a transformed coefficient by inversely quantizing the received coefficient level value (decoded displacement).

The inverse wavelet transform unit 206K is configured to generate and output a displacement by performing inverse wavelet transform on transformed coefficients received from the inverse quantization unit 206J.

Here, the inverse wavelet transform is an inverse transform of the wavelet transform. The wavelet transform is a method in which a wavelet function is used as a basis, the basis is enlarged for a low-frequency component, and the basis is reduced for a high-frequency component, so that spatial and frequency information can be simultaneously analyzed.

### (Syntax Configuration)

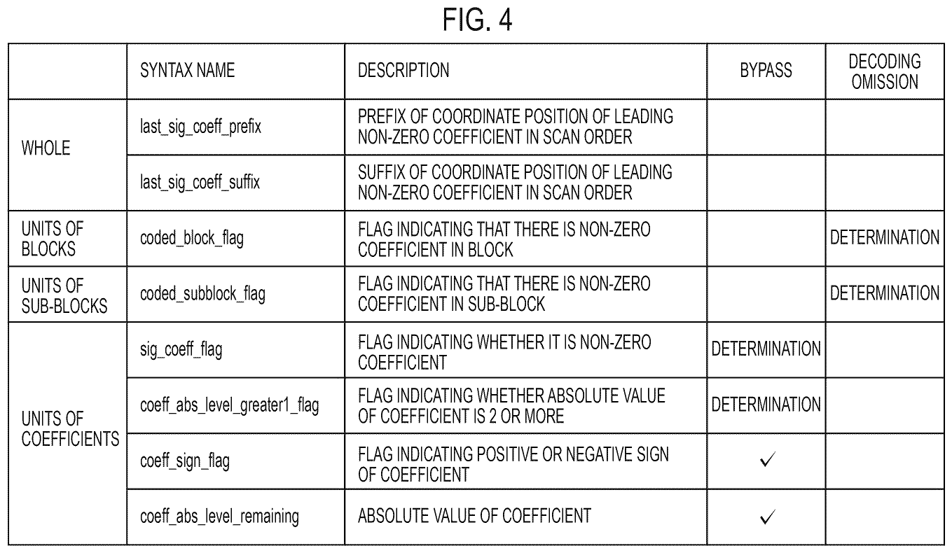

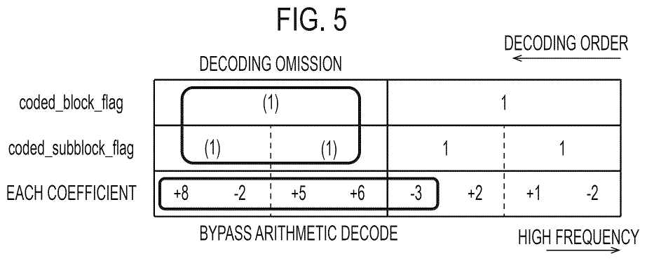

The syntax configuration will be described below with reference to FIGS. 4 and 5.

First, the coefficient level value of the decoded displacement is represented by three N-dimensional vectors in each frame. N indicates the total number of subdivided vertices. 3 indicates the number of bases, and the bases may be arbitrarily set.

For example, the above-described coefficient level value may be set to three directions of a normal direction, a Tangent direction, and a Bi-Tangent direction with respect to each subdivided vertex. Each vector is divided into blocks or sub-blocks and encoded in units of blocks or sub-blocks.

Each vector may be equally divided such that the size of each block is the same. The remaining elements constitute a block having the maximum size.

Alternatively, each vector may be divided such that the size of each block is different.

For example, the block size may be determined by the subdivision level indicated by the control information and the total number of coefficient level values at each level (n1, n2, . . . ). Here, the subdivision level indicates the number of times of subdivision. For example, in a case where the subdivision level is 4, it may be configured by four blocks having sizes of n1, n2, n3, and n4, respectively.

Each block is divided into finer sub-blocks. The block may be equally divided such that the size of each sub-block is the same. The remaining elements constitute a sub-block having the maximum size. The size of the sub-block may be different in each block.

FIG. 4 is a diagram illustrating an example of a syntax configuration. Syntax is defined in units of whole, blocks, sub-blocks, and coefficients.

First, syntax defined as a whole will be described. last_sig_coeff_prefix represents a prefix of the coordinate position of the leading non-zero coefficient in the scan order. last_sig_coeff_suffix represents a suffix of the coordinate position of the leading non-zero coefficient in the scan order. For example, the prefix is represented by truncated rice binarization and the suffix is represented by a fixed length.

Secondly, syntax defined in units of blocks will be described. coded_block_flag is a flag indicating that there is a non-zero coefficient in a block. Only one such flag is defined for each block.

Third, syntax defined in units of sub-blocks will be described. coded_subblock_flag is a flag indicating that there is a non-zero coefficient in the sub-block. Only one such flag is defined for each sub-block.

Fourth, syntax defined in units of coefficients will be described. sig_coeff_flag is a flag indicating whether the coefficient is a non-zero coefficient. coeff_abs_level_greater1_flag is a flag indicating whether the absolute value of the coefficient (non-zero coefficient) is 2 or more. coeff_sign_flag is a flag indicating a positive or negative sign of a coefficient. coeff_abs_level_remaining represents a value obtained by subtracting a value expressed by sig_coeff_flag and coeff_abs_level_greater1_flag from the absolute value of the coefficient. coeff_abs_level_remaining is expressed by, for example, a k-exponent Golomb code.

### (Arithmetic Decoding Unit 206B)

The arithmetic decoding unit 206B targets binary values. The arithmetic decoding unit 206B defines a number straight line from 0 to 1, and divides and uses the section. Such a section is divided by a binary occurrence probability (hereinafter, referred to as a context value).

The binary decimal is input to the arithmetic decoding unit 206B, and the arithmetic decoding unit 206B decodes the original value according to which section on the number straight line the binary decimal is included. The context value is received from the context selection unit 206E for each bit of the input signal and used for decoding.

### (Context Value Update Unit 206C)

The context value update unit 206C is configured to update the context value each time 1 bit is decoded.

Here, the context value update unit sets a symbol having a high occurrence probability among 0 and 1 as a most probable symbol (MPS), and sets a symbol having a low occurrence probability as a least probable symbol (LPS).

The context value update unit 206C may use a probability update table that slightly updates the probability value in a case where the MPS occurs and greatly updates the probability value in the case where the LPS occurs.

### (Bypass Arithmetic Decoding Unit 206A3)

The bypass arithmetic decoding unit 206A3 is configured to perform the arithmetic decoding using the context value similarly to the arithmetic decoding unit 206B.

Here, in the bypass arithmetic decoding unit 206A3, by setting the context value to a fixed value at all times, it is not necessary to update the context and select the context, and the calculation time can be reduced.

### (Decoding Omission Determination Unit 206A1)

The decoding omission determination unit 206A1 may be configured to determine whether decoding of coded_block_flag is omitted in some blocks and regarded as a predetermined value.

Furthermore, the decoding omission determination unit 206A1 may be configured to determine whether decoding of coded_subblock_flag is omitted in some sub-blocks and regarded as a predetermined value.

For example, in a case where the total number of decoded values reaches a predetermined threshold, the decoding omission determination unit 206A1 may omit decoding for the rest of coded_block_flag and regard the rest as 1.

For example, in a case where the total number of decoded values of 1 reaches a predetermined threshold, the decoding omission determination unit 206A1 may omit decoding for the rest of coded_block_flag and regard the rest as 1.

For example, in a case where the total number of decoded values reaches a predetermined threshold, the decoding omission determination unit 206A1 may omit decoding for the rest of coded_subblock_flag and regard the rest as 1.

For example, in a case where the total number of decoded values of 1 reaches a predetermined threshold, the decoding omission determination unit 206A1 may omit decoding for the rest of coded_subblock_flag and regard the rest as 1.

FIG. 5 illustrates an example of syntax in which the decoding omission determination unit 206A1 can determine that decoding is omitted.

### (Bypass Decoding Determination Unit 206A2)

The bypass decoding determination unit 206A2 is configured to determine whether to perform bypass arithmetic decoding on some coefficients.

Syntax in units of coefficients determined to be a target of bypass arithmetic decoding by the bypass decoding determination unit 206A2 is processed by the bypass arithmetic decoding unit 206A3.

For example, in a case where the total number of decoded values in each sub-block reaches a predetermined threshold, the bypass decoding determination unit 206A2 may perform bypass arithmetic decoding on the rest of sig_coeff_flag.

For example, in a case where the total number of decoded values of 1 in each sub-block reaches a predetermined threshold, the bypass decoding determination unit 206A2 may perform bypass arithmetic decoding on the rest of sig_coeff_flag.

For example, when the total number of decoded values in each sub-block reaches a predetermined threshold, the bypass decoding determination unit 206A2 may perform bypass arithmetic decoding on the rest of coeff_abs_level_greater1_flag.

For example, in a case where the total number of decoded values of 1 in each sub-block reaches a predetermined threshold, the bypass decoding determination unit 206A2 may perform bypass arithmetic decoding on the rest of coeff_abs_level_greater1_flag.

FIG. 5 illustrates an example of coefficients to be subjected to bypass arithmetic decoding by the bypass decoding determination unit 206A2.

### (Operation of Displacement Decoding Unit 206)

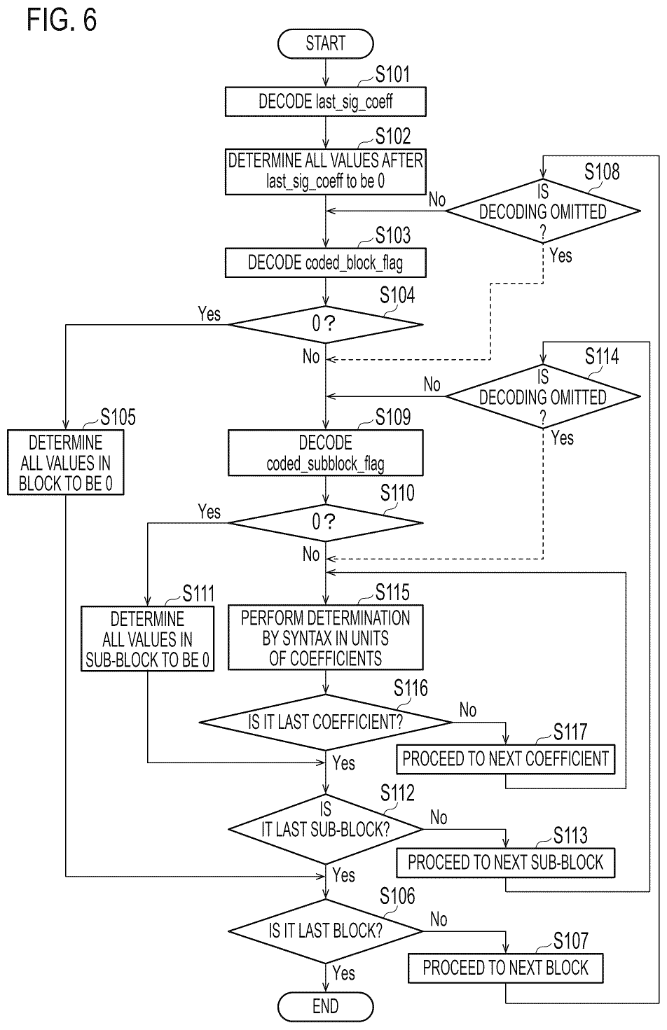

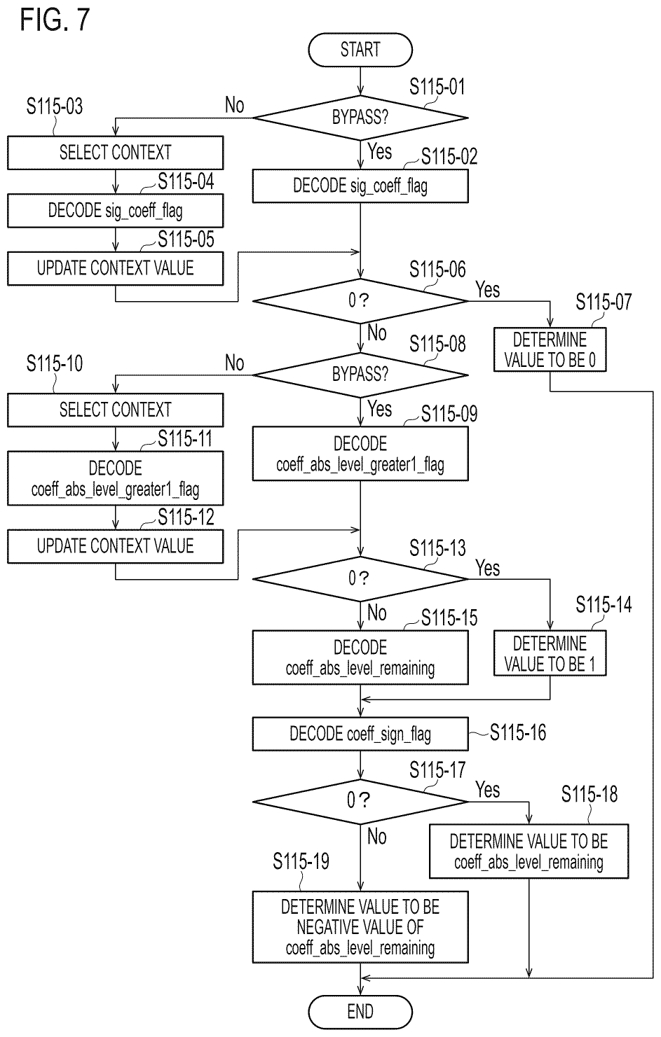

An example of the operation of the displacement decoding unit 206 will be described below with reference to FIGS. 6 and 7.

First, an example of an operation of the displacement decoding unit 206 will be described with reference to FIG. 6.

As illustrated in FIG. 6, in step S101, the arithmetic decoding unit 206B and the multi-value conversion unit 206F decode last_sig_coeff_prefix and last_sig_coeff_suffix.

In step S102, the coefficient level value decoding unit 206F2 determines all the coefficients after the position indicated by last_sig_coeff_prefix and last_sig_coeff_suffix to be 0.

In step S103, the arithmetic decoding unit 206B decodes coded_block_flag.

In step S104, the coefficient level value decoding unit 206F2 determines whether coded_block_flag is 0 or 1.

In the case of coded_block_flag=0, the present operation proceeds to step S105, and in the case of coded_block_flag=1, the present operation proceeds to step S109.

In step S105, the coefficient level value decoding unit 206F2 determines all the coefficients in the currently processed block to be 0.

In step S106, the coefficient level value decoding unit 206F2 determines whether the currently processed block is the final block. In the case of Yes, the present operation ends, and in the case of No, the present operation proceeds to step S107.

In step S107, the coefficient level value decoding unit 206F2 proceeds to the processing for the next block.

In step S108, the decoding omission determination unit 206A1 determines whether to omit decoding of coded_block_flag and regard it as 1. In the case of Yes, the present operation proceeds to step S109, and in the case of No, the present operation returns to step S103.

In step S109, the arithmetic decoding unit 206B decodes coded_subblock_flag.

In step S110, the coefficient level value decoding unit 206F2 determines whether coded_subblock_flag is 0 or 1. In the case of coded_subblock_flag=0, the present operation proceeds to step S111, and in the case of coded_subblock_flag=1, the present operation proceeds to step S115.

In step S111, the coefficient level value decoding unit 206F2 determines all the coefficients in the currently processed sub-block to be 0.

In step S112, the coefficient level value decoding unit 206F2 determines whether the currently processed sub-block is the final sub-block. In the case of Yes, the present operation proceeds to step S106, and in the case of No, the present operation proceeds to step S113.

In step S113, the coefficient level value decoding unit 206F2 proceeds to the processing for the next sub-block.

In step S114, the decoding omission determination unit 206A1 determines whether to omit decoding of coded_subblock_flag and regard it as 1. In the case of Yes, the present operation proceeds to step S115, and in the case of No, the present operation proceeds to step S109.

In step S115, the arithmetic decoding unit 206B and the multi-value conversion unit 206F perform determination by syntax in units of coefficients. Details of this step will be described later with reference to FIG. 7.

In step S116, the coefficient level value decoding unit 206F2 determines whether the currently processed coefficient is the last coefficient in the sub-block. In the case of Yes, the present operation proceeds to step S112, and in the case of No, the present operation proceeds to step S117.

FIG. 7 is a diagram illustrating an example of an operation of determination by the above-described syntax in units of coefficients.

In step S115-01, the bypass decoding determination unit 206A2 determines whether to perform bypass arithmetic decoding on sig_coeff_flag. In the case of Yes, the present operation proceeds to step S115-02, and in the case of No, the present operation proceeds to step S115-03.

In step S115-02, the arithmetic decoding unit 206B decodes sig_coeff_flag.

In step S115-03, the context selection unit 206E selects a context used for arithmetic decoding of sig_coeff_flag.

In step S115-04, the arithmetic decoding unit 206B decodes sig_coeff_flag.

In step S115-05, the context value update unit 206C updates the context value used for arithmetic decoding of sig_coeff_flag.

In step S115-06, the coefficient level value decoding unit 206F2 determines whether sig_coeff_flag is 0 or 1. In the case of sig_coeff_flag=0, the present operation proceeds to step S115-07, and in the case of sig_coeff_flag=1, the present operation proceeds to step S115-08.

In step S115-07, the coefficient level value decoding unit 206F2 determines the coefficient level value to be 0, and this operation ends.

In step S115-08, the bypass decoding determination unit 206A2 determines whether to perform bypass arithmetic decoding on coeff_abs_level_greater1_flag. In the case of Yes, the present operation proceeds to step S115-09, and in the case of No, the present operation proceeds to step S115-10.

In step S115-09, the arithmetic decoding unit 206B decodes coeff_abs_level_greater1_flag.

In step S115-10, the context selection unit 206E selects a context used for decoding coeff_abs_level_greater1_flag.

In step S115-11, the arithmetic decoding unit 206B decodes coeff_abs_level_greater1_flag.

In step S115-12, the context value update unit 206C updates the context value used for decoding coeff_abs_level_greater1_flag.

In step S115-13, the coefficient level value decoding unit 206F2 determines whether coeff_abs_level_greater1_flag is 0 or 1. In the case of coeff_abs_level_greater1_flag=0, the present operation proceeds to step S115-14, and in the case of coeff_abs_level_greater1_flag=1, the present operation proceeds to step S115-15.

In step S115-14, the coefficient level value decoding unit 206F2 determines the coefficient level value to be 1, and the process proceeds to step S115-16.

In step S115-15, the arithmetic decoding unit 206B and the multi-value conversion unit 206F decode coeff_abs_level_remaining.

In step S115-16, the arithmetic decoding unit 206B decodes coeff_sign_flag.

In step S115-17, the coefficient level value decoding unit 206F2 determines whether coeff_sign_flag is 0 or 1. In the case of coeff_sign_flag=0, the present operation proceeds to step S115-18, and in the case of coeff_sign_flag=1, the present operation proceeds to step S115-19.

In step S115-18, the coefficient level value decoding unit 206F2 determines the coefficient level value as coeff_abs_level_remaining, and this operation ends.

In step S115-19, the coefficient level value decoding unit determines the coefficient level value to be a negative value of coeff_abs_level_remaining, and this operation ends.

According to the mesh decoding device 200 of the present embodiment, a calculation amount can be reduced by partially omitting decoding of some syntax and regarding the decoding as a predetermined value or performing bypass arithmetic decoding on some coefficients.

The mesh encoding device 100 and the mesh decoding device 200 described above may be implemented as programs that cause a computer to execute each function (each step).

Note that, according to the present embodiment, for example, comprehensive improvement in service quality can be realized in moving image communication, and thus, it is possible to contribute to goal 9 “Establish a resilient infrastructure, promote sustainable industrialization, and expand innovation” of the sustainable development goals (SDGs) led by the United Nations.

1. A mesh decoding device comprising:
a circuit that decodes a displacement bit stream to generate and output a displacement, wherein
the circuit:
generates a binarization syntax by performing arithmetic decoding on the displacement bit stream;
generates a binarization syntax by performing bypass arithmetic decoding in which arithmetic decoding is performed while a context value is fixed with respect to the displacement bit stream;
generates the syntax by multi-value conversion of the binarization syntax;
generates a coefficient level value from the syntax x;
generates a transformed coefficient by inversely quantizing the coefficient level value; and
generates a displacement by applying an inverse wavelet transform to the transformed coefficient.

2. The mesh decoding device according to claim 1, wherein
the circuit:
decodes the binarization syntax in units of sub-blocks,
decodes the binarization syntax in units of sub-blocks,
generates the syntax in units of sub-blocks, and
generates the coefficient level value in units of sub-blocks.

3. The mesh decoding device according to claim 2, wherein
the circuit determines whether decoding of some syntax is omitted and the syntax is regarded as a predetermined value, and
in a case where a total number of decoded values in each sub-block reaches a predetermined threshold or in a case where a total number of the decoded values of 1 in each sub-block reaches the predetermined threshold, the circuit performs the bypass arithmetic decoding on all remaining flags indicating whether the remaining flags are non-zero coefficients.

4. The mesh decoding device according to claim 2, wherein
in a case where a total number of decoded values in each sub-block reaches a predetermined threshold or in a case where a total number of the decoded values of 1 in each sub-block reaches the predetermined threshold, the circuit performs the bypass arithmetic decoding on all remaining flags indicating whether an absolute value of a coefficient is 2 or more.

5. A mesh decoding method comprising:
decoding a displacement bit stream to generate and output a displacement, wherein
the decoding includes:
generating a binarization syntax by performing arithmetic decoding on the displacement bit stream;
generating a binarization syntax by performing bypass arithmetic decoding in which arithmetic decoding is performed while a context value is fixed with respect to the displacement bit stream;
generating the syntax by multi-value conversion of the binarization syntax;
generating a coefficient level value from the syntax;
generating a transformed coefficient by inversely quantizing the coefficient level value; and
generating a displacement by applying an inverse wavelet transform to the transformed coefficient.

6. A program stored on a non-transitory computer-readable medium for causing a computer to function as a mesh decoding device, wherein
the mesh decoding device includes a circuit, and
the circuit:
decodes a displacement bit stream to generate and output a displacement, and
the displacement decoding unit includes:
generates a binarization syntax by performing arithmetic decoding on the displacement bit stream;
generates a binarization syntax by performing bypass arithmetic decoding in which arithmetic decoding is performed while a context value is fixed with respect to the displacement bit stream;
generates the syntax by multi-value conversion of the binarization syntax;
generates a coefficient level value from the syntax;
generates a transformed coefficient by inversely quantizing the coefficient level value; and
generates a displacement by applying an inverse wavelet transform to the transformed coefficient.
